(19) United States
(12) Patent Application Publication
(10) Pub. No.: US 2026/0266222 A1
(43) Pub. Date: Sep. 10, 2026

(54) START CONTROL DEVICE, MOVING OBJECT, START CONTROL METHOD, AND NON-TRANSITORY COMPUTER-READABLE STORAGE MEDIUM

(71) Applicant: HONDA MOTOR CO., LTD., Tokyo (JP)

(72) Inventor: Hisao Haga, Wako-shi, Saitama-ken (JP)

(21) Appl. No.: 19/553,687

(22) Filed: Mar. 2, 2026

(30) Foreign Application Priority Data
Mar. 4, 2025 (JP) 2025-033408

(51) Int. Cl. F02C 7/268; B64C 29/00; B64D 27/33; B64D 31/18; B64D 33/00; B64D 35/024

(52) U.S. Cl. CPC F02C 7/268; B64C 29/0016; B64D 27/33; B64D 31/18; B64D 33/00; B64D 35/024; F05D 2260/85

(57) ABSTRACT

A start control device controls a starting device for an internal combustion engine that drives a generator that supplies electric power to a moving object, the start control device including: a target rotational speed determination unit that can sequentially determine a target rotational speed of the internal combustion engine so that a rotational acceleration of the internal combustion engine becomes a target rotational acceleration; and a command torque determination unit that determines, based on the target rotational speed determined by the target rotational speed determination unit, a command torque for controlling the starting device.

### CROSS-REFERENCE TO RELATED APPLICATIONS

This application is based upon and claims the benefit of priority from Japanese Patent Application No. 2025-033408 filed on March 4, 2025, the contents of which are incorporated herein by reference.

### BACKGROUND OF THE INVENTION

### Field of the Invention

The present disclosure relates to a start control device, a moving object, a start control method, and a non-transitory computer-readable storage medium.

### Description of the Related Art

JP 2024-145964 A discloses a power control device. The power control device controls a starting mechanism to start an internal combustion engine by the starting mechanism.

### SUMMARY OF THE INVENTION

There has been a demand for a more satisfactory start control device and the like.

The present disclosure has the object of solving the above-described problem.

A first aspect of the present disclosure is characterized by a start control device that controls a starting device for an internal combustion engine configured to drive a generator configured to supply electric power to a moving object, the start control device comprising: a target rotational speed determination unit configured to sequentially determine a target rotational speed of the internal combustion engine in a manner so that a rotational acceleration of the internal combustion engine becomes a target rotational acceleration; and a command torque determination unit configured to determine, based on the target rotational speed determined by the target rotational speed determination unit, a command torque for controlling the starting device.

A second aspect of the present disclosure is characterized by a moving object comprising: the start control device according to the first aspect; the generator; and the internal combustion engine.

A third aspect of the present disclosure is characterized by a start control method for controlling a starting device for an internal combustion engine configured to drive a generator configured to supply electric power to a moving object, the start control method comprising: causing a target rotational speed determination unit to sequentially determine a target rotational speed of the internal combustion engine in a manner so that a rotational acceleration of the internal combustion engine becomes a target rotational acceleration; and causing a command torque determination unit to determine, based on the target rotational speed determined by the target rotational speed determination unit, a command torque for controlling the starting device.

A fourth aspect of the present disclosure is characterized by a program for causing a computer to execute the start control method according to the third aspect.

A fifth aspect of the present disclosure is characterized by a non-transitory computer-readable storage medium configured to store the program according to the fourth aspect.

According to the present disclosure, a more satisfactory start control device and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object according to an embodiment of the present disclosure;

FIG. 2 is a schematic diagram showing a configuration of a power supply system according to the embodiment;

FIG. 3 is a block diagram showing a control system according to the embodiment;

FIG. 4 is a block diagram showing a configuration of a management control device and a configuration of a power generation control device according to the embodiment;

FIG. 5 is a block diagram of a target rotational speed determination unit according to the embodiment;

FIG. 6 is a diagram explaining a target rotational speed according to the embodiment;

FIG. 7 is a diagram showing a command torque map according to the embodiment;

FIG. 8 is a flowchart of start control executed by the management control device and the power generation control device according to the embodiment; and

FIG. 9 is an image diagram showing an amount of electric power consumed by a generator at the time of starting an internal combustion engine according to the embodiment.

### DETAILED DESCRIPTION OF THE INVENTION

In the case where an internal combustion engine is started, a starting device is driven by using electric power supplied from a battery, and the internal combustion engine is rotated at a starting rotational speed by the starting device. By supplying a fuel to the internal combustion engine and igniting the supplied fuel in a state in which the internal combustion engine is rotating at the starting rotational speed, the internal combustion engine can rotate in a self-sustaining manner.

Conventionally, a command torque is determined according to the starting rotational speed of the internal combustion engine, and the starting device is controlled according to the constant command torque. In this case, there is a problem that the amount of electric power required to start the internal combustion engine is relatively large and the amount of electric power consumed by the battery is relatively large.

According to the start control device of the present disclosure, the amount of electric power required to start the internal combustion engine can be suppressed, and the amount of electric power consumed by the battery can be suppressed.

### Embodiments

### Configuration of Moving Object

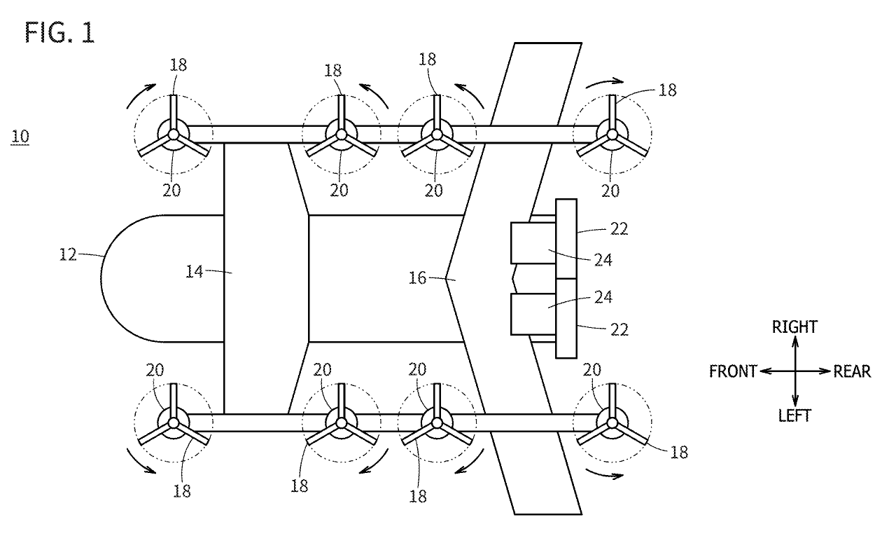

FIG. 1 is a schematic diagram of a moving object 10 according to an embodiment of the present disclosure. The moving object 10 of the embodiment is an electric vertical take-off and landing aircraft (eVTOL aircraft). The moving object 10 includes a fuselage 12. The fuselage 12 is provided with a cockpit, a cabin, and the like. A pilot rides in the cockpit and controls the moving object 10. Passengers and the like ride in the cabin. The moving object 10 may be automatically controlled.

The moving object 10 includes a front wing 14 and a rear wing 16. In the case where the moving object 10 moves forward, lift is generated in each of the front wing 14 and the rear wing 16.

The moving object 10 includes eight VTOL rotors 18 and two cruise rotors 22. One VTOL electric motor 20 is provided for one VTOL rotor 18. The VTOL electric motor 20 is a single three-phase motor. One cruise electric motor 24 is provided for one cruise rotor 22. The cruise electric motor 24 is a dual three-phase motor.

### Configuration of Power Supply System

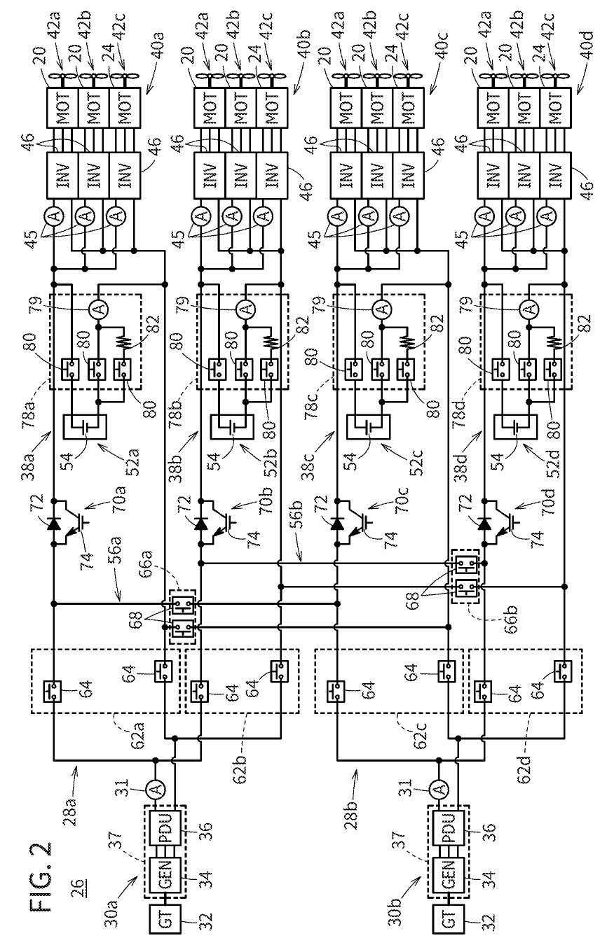

FIG. 2 is a schematic diagram showing a configuration of a power supply system 26 according to the embodiment. The power supply system 26 includes two power supply subsystems, that is, a first power supply subsystem 28a and a second power supply subsystem 28b. The power supply system 26 includes two power generation devices 30 as main power sources. The two power generation devices 30 are a power generation device 30a and a power generation device 30b. The power generation device 30a is provided in the first power supply subsystem 28a, and the power generation device 30b is provided in the second power supply subsystem 28b.

Each of the power generation devices 30 includes an internal combustion engine 32, a generator 34, and a power drive unit (hereinafter, referred to as a PDU) 36. The internal combustion engine 32 is a gas turbine engine. The internal combustion engine 32 may be a reciprocating engine instead of the gas turbine engine. The generator 34 is a motor generator. The internal combustion engine 32 drives the generator 34. As a result, the generator 34 generates electric power. The PDU 36 is an inverter including a switching element. By controlling the switching element, the PDU 36 converts the AC power generated by the generator 34 into DC power and outputs the DC power.

In the case where the internal combustion engine 32 is started, by controlling the switching element, the PDU 36 converts the DC power input to the PDU 36 into three-phase AC power and outputs the three-phase AC power to the generator 34. The three-phase AC power causes the generator 34 to operate, and the generator 34 starts the internal combustion engine 32. In the case where the internal combustion engine 32 is started, the generator 34 and the PDU 36 function as a starting device 37. It should be noted that a starting device that starts the internal combustion engine 32 may be provided separately from the generator 34 and the PDU 36.

In the case where a mechanism such as a clutch for cutting off the rotational torque is not provided between the internal combustion engine 32 and the generator 34, the rotor of the internal combustion engine 32 and the rotor of the generator 34 rotate integrally. In the case where a starting device that starts the internal combustion engine 32 is provided separately from the generator 34 and the PDU 36 as described above, the starting device needs to rotate the generator 34 together with the internal combustion engine 32 when starting the internal combustion engine 32. Therefore, a relatively large workload is required for the starting device until the rotational speed of the internal combustion engine 32 is increased to an idling rotational speed (a starting rotational speed).

It should be noted that the above description does not exclude, from the present invention, a configuration in which a clutch or the like for cutting off the rotational torque is provided between the internal combustion engine 32 and the generator 34. The present invention also includes a configuration in which a clutch or the like for cutting off the rotational torque is provided between the internal combustion engine 32 and the generator 34.

The power generation devices 30 each include a current sensor 31. The current sensor 31 detects the current of electric power input to and output from each power generation device 30. The current sensor 31 is provided on the positive wire, but may be provided on the negative wire.

The power generation devices 30 may each include various sensors such as a voltage sensor, and elements such as a fuse, a relay, a breaker, a diode, a transistor, a resistor, a coil, and a capacitor.

The power supply system 26 includes four power supply circuits 38. The four power supply circuits 38 are a power supply circuit 38a, a power supply circuit 38b, a power supply circuit 38c, and a power supply circuit 38d.

The power supply system 26 includes four load modules 40. The four load modules 40 are a load module 40a, a load module 40b, a load module 40c, and a load module 40d.

The power supply circuit 38a supplies, to the load module 40a, the DC power supplied from the power generation device 30a. The power supply circuit 38b supplies, to the load module 40b, the DC power supplied from the power generation device 30a. The power supply circuit 38c supplies, to the load module 40c, the DC power supplied from the power generation device 30b. The power supply circuit 38d supplies, to the load module 40d, the DC power supplied from the power generation device 30b.

The load modules 40 each include three load devices 42. The three load devices 42 are a load device 42a, a load device 42b, and a load device 42c.

The load device 42a and the load device 42b each include a drive device 46 and the VTOL electric motor 20. The load device 42c includes the drive device 46 and the cruise electric motor 24. The drive device 46 is an inverter including a switching element. By controlling the switching element, the drive device 46 converts the DC power input to the drive device 46 into three-phase AC power, and outputs the three-phase AC power to the VTOL electric motor 20 or the cruise electric motor 24. By controlling the switching element, the drive device 46 can disconnect the load device 42 from the power supply circuit 38.

It should be noted that the cruise electric motor 24 of the load device 42c of the load module 40a and the cruise electric motor 24 of the load device 42c of the load module 40c are the same electric motor. Further, the cruise electric motor 24 of the load device 42c of the load module 40b and the cruise electric motor 24 of the load device 42c of the load module 40d are the same electric motor. As described above, the cruise electric motor 24 is a dual three-phase motor and is driven by two drive devices 46.

The load devices 42 each include a current sensor 45. The current sensor 45 detects the current of electric power input to and output from each load device 42. The current sensor 45 is provided on the positive wire, but may be provided on the negative wire.

The load devices 42 may each include various sensors such as a voltage sensor, and elements such as a fuse, a relay, a breaker, a diode, a transistor, a resistor, a coil, and a capacitor.

The power supply system 26 includes four power storage devices 52. The four power storage devices 52 are a power storage device 52a, a power storage device 52b, a power storage device 52c, and a power storage device 52d. The power storage device 52 is connected to each power supply circuit 38. The power storage device 52 is connected in parallel with the power generation device 30. The power storage devices 52 each include a battery 54. The battery 54 is, for example, a lithium ion battery.

The power storage devices 52 may each include various sensors such as a voltage sensor, and elements such as a fuse, a relay, a breaker, a diode, a transistor, a resistor, a coil, and a capacitor.

The power supply circuit 38a and the power supply circuit 38c can be connected by a connection circuit 56a. The power supply circuit 38b and the power supply circuit 38d can be connected by a connection circuit 56b.

The power supply system 26 includes four first disconnection devices 62. The four first disconnection devices 62 are a first disconnection device 62a, a first disconnection device 62b, a first disconnection device 62c, and a first disconnection device 62d. The first disconnection devices 62 each include two contactors 64. One contactor 64 is provided on the positive wire, and another contactor 64 is provided on the negative wire.

The first disconnection device 62a can disconnect the power generation device 30a from the power supply circuit 38a. The first disconnection device 62b can disconnect the power generation device 30a from the power supply circuit 38b. The first disconnection device 62c can disconnect the power generation device 30b from the power supply circuit 38c. The first disconnection device 62d can disconnect the power generation device 30b from the power supply circuit 38d.

The power supply system 26 includes two connection devices 66. The two connection devices 66 are a connection device 66a and a connection device 66b. The connection devices 66 each include two contactors 68. One contactor 68 is provided on the positive wire, and another contactor 68 is provided on the negative wire.

The connection device 66a can connect the power supply circuit 38a and the power supply circuit 38c via the connection circuit 56a. The connection device 66b can connect the power supply circuit 38b and the power supply circuit 38d via the connection circuit 56b.

The power supply system 26 includes four backflow prevention devices 70. The four backflow prevention devices 70 are a backflow prevention device 70a, a backflow prevention device 70b, a backflow prevention device 70c, and a backflow prevention device 70d. The backflow prevention device 70a is provided on the positive side of the power supply circuit 38a. The backflow prevention device 70b is provided on the positive side of the power supply circuit 38b. The backflow prevention device 70c is provided on the positive side of the power supply circuit 38c. The backflow prevention device 70d is provided on the positive side of the power supply circuit 38d. Each backflow prevention device 70 may be provided on the negative side of each power supply circuit 38.

The backflow prevention devices 70 each include a diode 72, and an insulated gate bipolar transistor (hereinafter, referred to as an IGBT) 74. Normally, the IGBT 74 is turned off. In the case where the IGBT 74 is OFF, the diode 72 prevents a backflow of the current in each of the power supply circuit 38a, the power supply circuit 38b, the power supply circuit 38c, and the power supply circuit 38d. In the case where the internal combustion engine 32 is started, the IGBT 74 is turned on. In the case where the IGBT 74 is ON, by bypassing the diode 72, the backflow of the current is allowed in each of the power supply circuits 38. As a result, the electric power of the battery 54 can be supplied to the starting device 37. Instead of the IGBT 74, an element such as a contactor or a relay may be used in each of the backflow prevention devices 70.

The power supply system 26 includes four second disconnection devices 78. The four second disconnection devices 78 are a second disconnection device 78a, a second disconnection device 78b, a second disconnection device 78c, and a second disconnection device 78d.

The second disconnection devices 78 each include three contactors 80 and one precharge resistor 82. One contactor 80 of the three contactors 80 is provided on the positive wire. Another contactor 80 of the three contactors 80 is provided on the negative wire. Still another contactor 80 of the three contactors 80 is provided in a precharge circuit that bypasses the contactor 80 provided on the negative wire. The precharge resistor 82 is provided in series with the contactor 80 in the precharge circuit.

The second disconnection device 78a can disconnect the power storage device 52a from the power supply circuit 38a. The second disconnection device 78b can disconnect the power storage device 52b from the power supply circuit 38b. The second disconnection device 78c can disconnect the power storage device 52c from the power supply circuit 38c. The second disconnection device 78d can disconnect the power storage device 52d from the power supply circuit 38d.

In the case where the power generation device 30a and the load module 40a are precharged with the DC power of the power storage device 52a, the second disconnection device 78a outputs the DC power from the power storage device 52a to the power supply circuit 38a via the precharge circuit. In the case where the power generation device 30a and the load module 40b are precharged with the DC power of the power storage device 52b, the second disconnection device 78b outputs the DC power from the power storage device 52b to the power supply circuit 38b via the precharge circuit. In the case where the power generation device 30b and the load module 40c are precharged with the DC power of the power storage device 52c, the second disconnection device 78c outputs the DC power from the power storage device 52c to the power supply circuit 38c via the precharge circuit. In the case where the power generation device 30b and the load module 40d are precharged with the DC power of the power storage device 52d, the second disconnection device 78d outputs the DC power from the power storage device 52d to the power supply circuit 38d via the precharge circuit.

The second disconnection devices 78 each include a current sensor 79. The current sensor 79 detects the current of electric power input to and output from each second disconnection device 78.

### Configuration of Control System

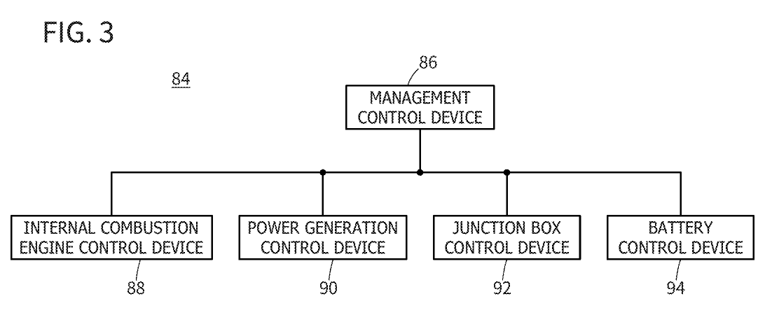

The moving object 10 includes a control system 84. FIG. 3 is a block diagram showing the control system 84 according to the embodiment.

The control system 84 includes a management control device 86, an internal combustion engine control device 88, a power generation control device 90, a junction box control device 92, and a battery control device 94.

The management control device 86 is a control device that manages the internal combustion engine control device 88, the power generation control device 90, the junction box control device 92, and the battery control device 94. The internal combustion engine control device 88 controls the internal combustion engines 32. The power generation control device 90 controls the PDUs 36. The junction box control device 92 controls the first disconnection devices 62, the connection devices 66, the IGBTs 74, and the like. The battery control device 94 monitors the state of charge (SOC) of the batteries 54, and controls the second disconnection devices 78 and the like.

### Configuration of Start Control Device

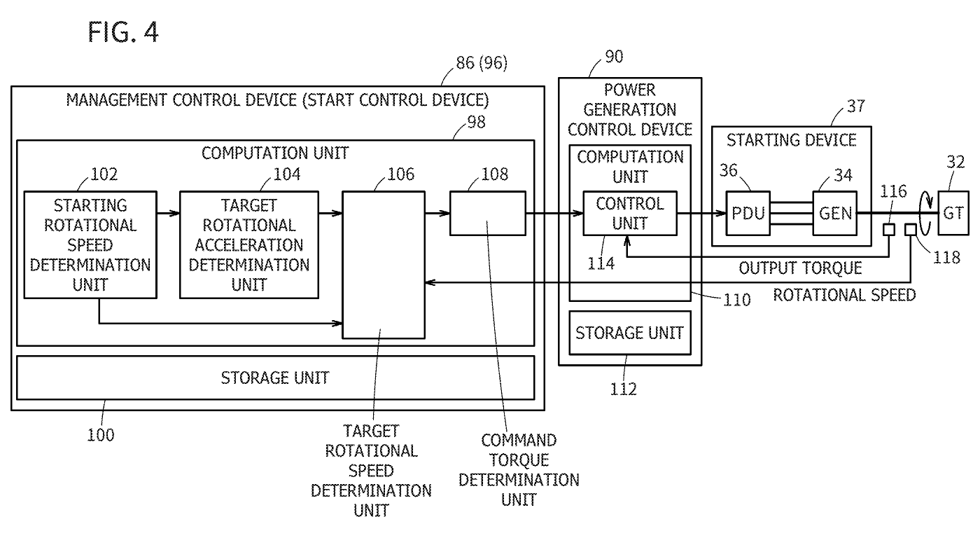

FIG. 4 is a block diagram showing a configuration of the management control device 86 and a configuration of the power generation control device 90 according to the embodiment. In the case where the internal combustion engine 32 is started by the starting device 37, the management control device 86 functions as a start control device 96.

The management control device 86 includes a computation unit 98 and a storage unit 100. The computation unit 98 is, for example, a processor such as a central processing unit (CPU) or a graphics processing unit (GPU). The computation unit 98 includes a starting rotational speed determination unit 102, a target rotational acceleration determination unit 104, a target rotational speed determination unit 106, and a command torque determination unit 108. The starting rotational speed determination unit 102, the target rotational acceleration determination unit 104, the target rotational speed determination unit 106, and the command torque determination unit 108 are realized by the computation unit 98 executing a program stored in the storage unit 100. At least part of the starting rotational speed determination unit 102, the target rotational acceleration determination unit 104, the target rotational speed determination unit 106, and the command torque determination unit 108 may be realized by an integrated circuit such as an application specific integrated circuit (ASIC) or a field-programmable gate array (FPGA). At least part of the starting rotational speed determination unit 102, the target rotational acceleration determination unit 104, the target rotational speed determination unit 106, and the command torque determination unit 108 may be realized by an electronic circuit including a discrete device.

The storage unit 100 is a non-transitory computer-readable tangible storage medium. The storage unit 100 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 100 may be included in the processor, the integrated circuit, or the like described above. At least part of the storage unit 100 may be mounted on a device connected to the moving object 10 via a network.

The starting rotational speed determination unit 102 determines a starting rotational speed of the internal combustion engine 32. The starting rotational speed is a rotational speed at which the internal combustion engine 32 can rotate in a self-sustaining manner. The starting rotational speed is determined based on the outside air temperature and the like because the starting rotational speed changes depending on the viscosity of the oil and the like that change depending on the outside air temperature and the like.

The target rotational acceleration determination unit 104 determines a target rotational acceleration of the internal combustion engine 32 at which the internal combustion engine 32 is started. The target rotational acceleration is indicated by, for example, a rate of increase in a target rotational speed per second. The target rotational acceleration is determined so that the rotational speed of the internal combustion engine 32 reaches the starting rotational speed in a predetermined time from a state in which the rotational speed is 0 [rpm].

The target rotational speed determination unit 106 determines a target rotational speed of the internal combustion engine 32 at which the internal combustion engine 32 is started. The determination of the target rotational speed will be described in detail later.

Based on the target rotational speed determined by the target rotational speed determination unit 106, the command torque determination unit 108 determines a command torque for controlling the starting device 37. The command torque is determined based on the torque required to maintain the rotational speed of the internal combustion engine 32 at the target rotational speed.

The power generation control device 90 includes a computation unit 110 and a storage unit 112. The computation unit 110 is, for example, a processor such as a CPU or a GPU. The computation unit 110 includes a control unit 114. The control unit 114 is realized by the computation unit 110 executing a program stored in the storage unit 112. At least part of the control unit 114 may be realized by an integrated circuit such as an ASIC or an FPGA. At least part of the control unit 114 may be realized by an electronic circuit including a discrete device.

The storage unit 112 is a non-transitory computer-readable tangible storage medium. The storage unit 112 is constituted by a volatile memory (not shown) and a non-volatile memory (not shown). The volatile memory is, for example, a RAM or the like. The non-volatile memory is, for example, a ROM, a flash memory, or the like. Data and the like are stored in, for example, the volatile memory. Programs, tables, maps, and the like are stored in, for example, the non-volatile memory. At least part of the storage unit 112 may be included in the processor, the integrated circuit, or the like described above. At least part of the storage unit 112 may be mounted on a device connected to the moving object 10 via a network.

The control unit 114 performs feedback control on the starting device 37 according to the command torque determined by the command torque determination unit 108 and an output torque of the generator 34 detected by a torque sensor 116. Specifically, the control unit 114 drives the PDU 36 so that the output torque of the generator 34 becomes the command torque and controls the voltage of the AC power applied to the generator 34.

### Target Rotational Speed

The start control device 96 according to the embodiment has two modes of a quick start mode and an energy-saving start mode as modes for starting the internal combustion engine 32.

In the case where the internal combustion engine 32 is started in a state in which the moving object 10 is moving, the quick start mode is selected. The state in which the moving object 10 is moving indicates, for example, that the moving object 10, which is an eVTOL aircraft, is flying. In the case where the internal combustion engine 32 stalls while the moving object 10 is flying, the quick start mode is selected in which the internal combustion engine 32 is started in as short a time as possible.

In the case where the internal combustion engine 32 is started in a state in which the moving object 10 is not moving, the energy-saving start mode is selected. The state in which the moving object 10 is not moving indicates, for example, that the moving object 10 is on standby on the ground. In the case where the internal combustion engine 32 is started while the moving object 10 is on standby on the ground, the energy-saving start mode is selected in which the amount of electric power required to start the internal combustion engine 32, that is, the amount of electric power consumed by the generator 34, is suppressed.

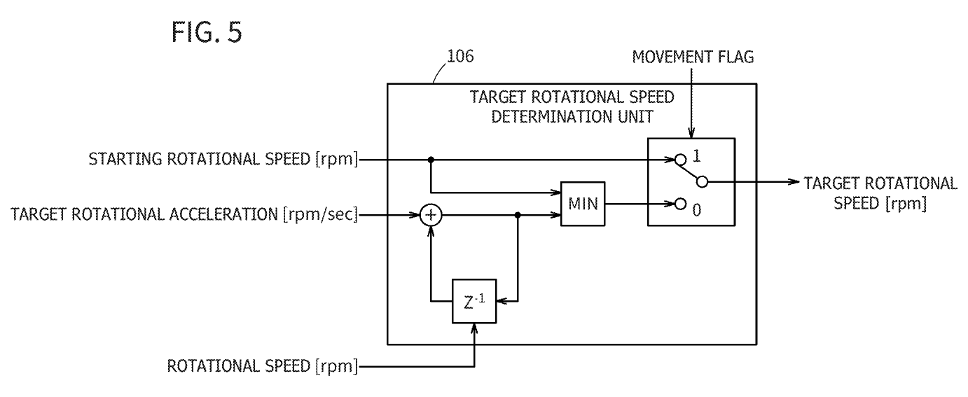

FIG. 5 is a block diagram of the target rotational speed determination unit 106 according to the embodiment. In the case where a movement flag in FIG. 5 is "1", it indicates a state in which the moving object 10 is moving. In the case where the movement flag in FIG. 5 is "0", it indicates a state in which the moving object 10 is not moving.

In the case where the movement flag is "1", the target rotational speed determination unit 106 determines the starting rotational speed as the target rotational speed (the quick start mode).

In the case where the movement flag is "0", the target rotational speed determination unit 106 sequentially determines the target rotational speed of the internal combustion engine 32 so that the rotational acceleration of the internal combustion engine 32 becomes the target rotational acceleration (the energy-saving start mode). The target rotational speed determination unit 106 determines the target rotational speed, for example, at a one-second cycle. The target rotational speed determination unit 106 determines, as the target rotational speed in the current cycle, a value obtained by adding the target rotational acceleration to the target rotational speed in the previous cycle. In the case where the target rotational speed determined based on the target rotational acceleration is higher than the starting rotational speed, the target rotational speed determination unit 106 determines the starting rotational speed as the target rotational speed. The rotational speed of the generator 34 detected by a rotational speed sensor 118 (FIG. 4) may be used as an initial value of the target rotational speed in the previous cycle.

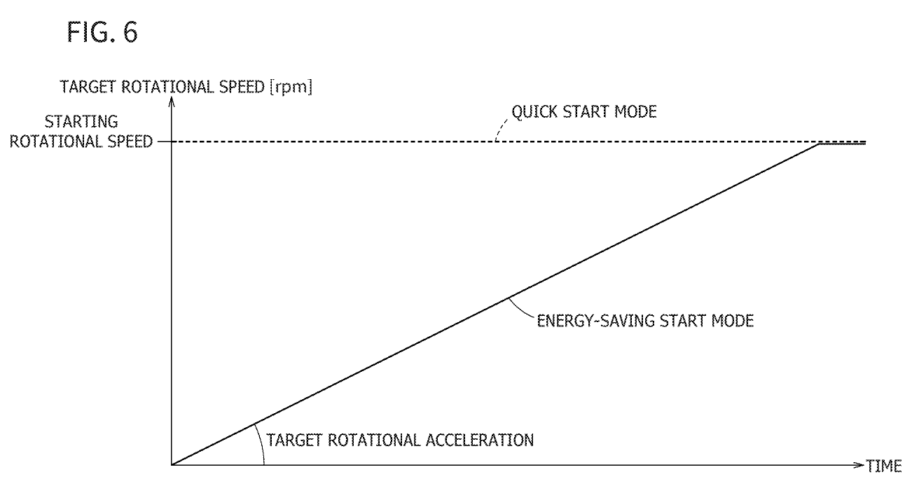

FIG. 6 is a diagram explaining the target rotational speed according to the embodiment. In the case where the quick start mode is selected, the target rotational speed is constant as shown in FIG. 6. On the other hand, in the case where the energy-saving start mode is selected, the target rotational speed changes with time as shown in FIG. 6.

### Command Torque

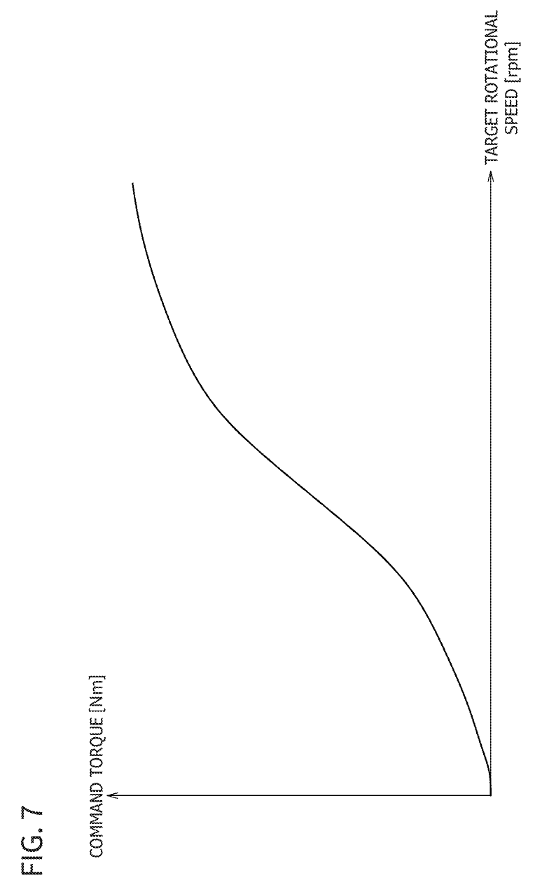

FIG. 7 is a diagram showing a command torque map according to the embodiment. The map in FIG. 7 is created based on the torque required to maintain the rotational speed of the internal combustion engine 32 at the target rotational speed. The command torque determination unit 108 determines, as the command torque, a value corresponding to the target rotational speed read from the command torque map.

The command torque determination unit 108 may determine the command torque using a calculation formula or the like without using the command torque map.

### Start Control

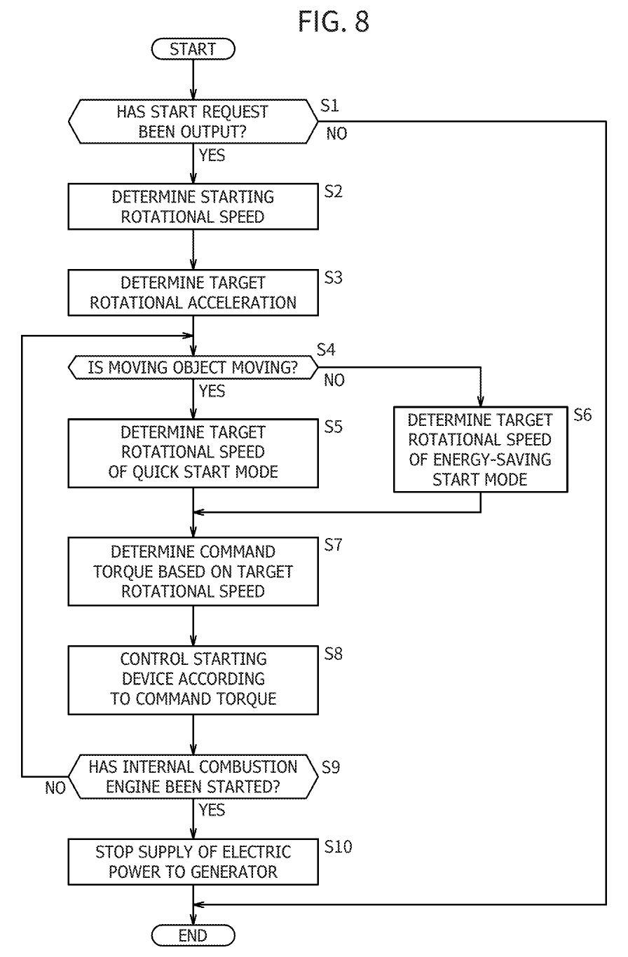

FIG. 8 is a flowchart of start control executed by the management control device 86 and the power generation control device 90 according to the embodiment. The start control is repeatedly executed at a predetermined cycle.

In step S1, the management control device 86 determines whether or not a start request has been output. In the case where it is determined that the start request has been output (step S1: YES), the process proceeds to step S2. In the case where it is determined that the start request has not been output (step S1: NO), the start control is ended. The start request is output, for example, in the case where the pilot performs a predetermined operation.

In step S2, the starting rotational speed determination unit 102 determines the starting rotational speed. Thereafter, the process proceeds to step S3.

In step S3, the target rotational acceleration determination unit 104 determines the target rotational acceleration. Thereafter, the process proceeds to step S4.

In step S4, the target rotational speed determination unit 106 determines whether or not the moving object 10 is moving. In the case where it is determined that the moving object 10 is moving, the process proceeds to step S5. In the case where it is determined that the moving object 10 is not moving, the process proceeds to step S6.

In step S5, the target rotational speed determination unit 106 determines the target rotational speed of the quick start mode. That is, the target rotational speed determination unit 106 determines the starting rotational speed as the target rotational speed. Thereafter, the process proceeds to step S7.

In step S6, the target rotational speed determination unit 106 determines the target rotational speed of the energy-saving start mode. That is, the target rotational speed determination unit 106 determines the target rotational speed so that the rotational acceleration of the internal combustion engine 32 becomes the target rotational acceleration. Thereafter, the process proceeds to step S7.

In step S7, the command torque determination unit 108 determines the command torque based on the target rotational speed. Thereafter, the process proceeds to step S8.

In step S8, the control unit 114 controls the starting device 37 according to the command torque. Specifically, the control unit 114 drives the PDU 36 to perform control so that the output torque of the generator 34 becomes the command torque. Thereafter, the process proceeds to step S9.

In step S9, the management control device 86 determines whether or not the internal combustion engine 32 has been started. In the case where it is determined that the internal combustion engine 32 has been started, the process proceeds to step S10. In the case where it is determined that the internal combustion engine 32 has not been started, the process returns to step S4.

In step S10, the control unit 114 controls the PDU 36 to stop the supply of electric power to the generator 34.

### Comparison of Amount of Electric Power Consumption

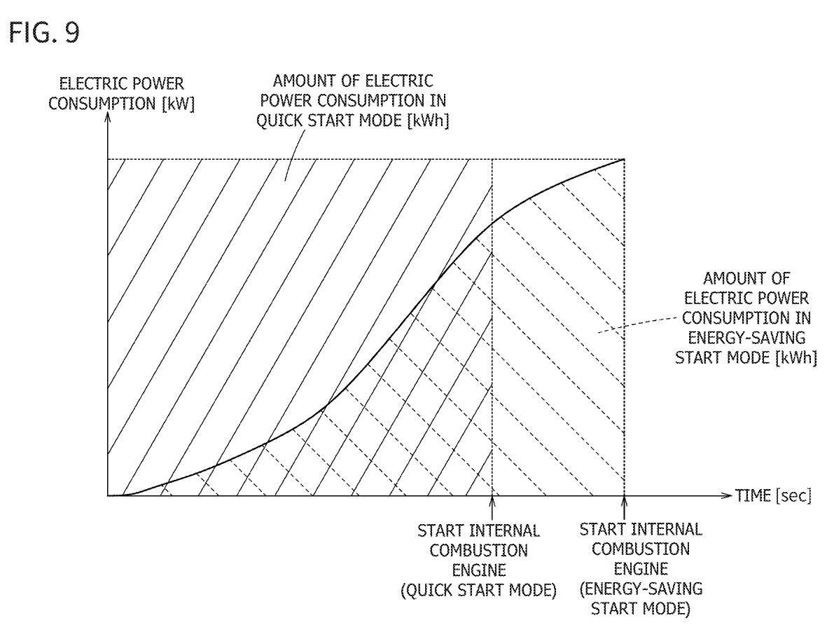

FIG. 9 is an image diagram showing an amount of electric power consumed by the generator 34 at the time of starting the internal combustion engine 32 according to the embodiment. FIG. 9 shows the amount of electric power consumption in the quick start mode and the amount of electric power consumption in the energy-saving start mode.

As shown in FIG. 9, the start timing of the internal combustion engine 32 in the energy-saving start mode is later than the start timing of the internal combustion engine 32 in the quick start mode. However, the amount of electric power consumed by the generator 34 in the energy-saving start mode is smaller than the amount of electric power consumed by the generator 34 in the quick start mode.

In a state in which the moving object 10 is not moving, such as during standby on the ground, the internal combustion engine 32 is started in the energy-saving start mode. As a result, although it takes time until the internal combustion engine 32 is started, the amount of electric power consumed by the generator 34 for starting the internal combustion engine 32 can be suppressed.

In a state in which the moving object 10 is moving, such as during flight, the internal combustion engine 32 is started in the quick start mode. As a result, the time required to start the internal combustion engine 32 can be shortened.

The following supplementary notes are further disclosed in relation to the above-described embodiment.

### Supplementary Note 1

The start control device (96) of the present disclosure is a start control device that controls the starting device (37) for the internal combustion engine (32) configured to drive the generator (34) configured to supply electric power to the moving object (10), and includes: the target rotational speed determination unit (106) configured to sequentially determine the target rotational speed of the internal combustion engine in a manner so that the rotational acceleration of the internal combustion engine becomes the target rotational acceleration; and the command torque determination unit (108) configured to determine, based on the target rotational speed determined by the target rotational speed determination unit, a command torque for controlling the starting device. According to this feature, the amount of electric power consumed by the starting device can be suppressed.

### Supplementary Note 2

In the start control device according to Supplementary Note 1, in the case where the internal combustion engine is started in a state in which the moving object is not moving, the target rotational speed determination unit may sequentially determine the target rotational speed based on the target rotational acceleration, and in the case where the internal combustion engine is started in a state in which the moving object is moving, the target rotational speed determination unit may determine the starting rotational speed of the internal combustion engine as the target rotational speed. According to this feature, in a state in which the moving object is moving, the time required to start the internal combustion engine can be shortened.

### Supplementary Note 3

In the start control device according to Supplementary Note 1, the command torque determination unit may determine the command torque based on information relating to the torque required to maintain the rotational speed of the internal combustion engine at the target rotational speed.

### Supplementary Note 4

The start control device according to Supplementary Note 1 may further include: the starting rotational speed determination unit (102) configured to determine the starting rotational speed of the internal combustion engine; and the target rotational acceleration determination unit (104) configured to determine the target rotational acceleration based on the starting rotational speed determined by the starting rotational speed determination unit, wherein the target rotational speed determination unit may sequentially determine the target rotational speed in a manner so that the rotational acceleration of the internal combustion engine becomes the target rotational acceleration determined by the target rotational acceleration determination unit.

### Supplementary Note 5

In the start control device according to Supplementary Note 1, the starting device may include the generator.

### Supplementary Note 6

In the start control device according to Supplementary Note 1, the internal combustion engine may be a gas turbine engine, and transmission of the rotational torque between the gas turbine engine and the generator may be uninterruptible.

### Supplementary Note 7

The moving object (10) of the present disclosure includes: the start control device according to any one of Supplementary Notes 1 to 6; the generator; and the internal combustion engine.

### Supplementary Note 8

The start control method of the present disclosure is a start control method for controlling the starting device for the internal combustion engine configured to drive the generator configured to supply electric power to the moving object, the start control method including: causing the target rotational speed determination unit to sequentially determine the target rotational speed of the internal combustion engine in a manner so that the rotational acceleration of the internal combustion engine becomes the target rotational acceleration; and causing the command torque determination unit to determine, based on the target rotational speed determined by the target rotational speed determination unit, a command torque for controlling the starting device.

### Supplementary Note 9

In the start control method according to Supplementary Note 8, in the case where the internal combustion engine is started in a state in which the moving object is not moving, the target rotational speed determination unit may sequentially determine the target rotational speed based on the target rotational acceleration, and in the case where the internal combustion engine is started in a state in which the moving object is moving, the target rotational speed determination unit may determine the starting rotational speed of the internal combustion engine as the target rotational speed.

### Supplementary Note 10

In the start control method according to Supplementary Note 8, the command torque determination unit may determine the command torque based on information relating to the torque required to maintain the rotational speed of the internal combustion engine at the target rotational speed.

### Supplementary Note 11

In the start control method according to Supplementary Note 8, the starting rotational speed of the internal combustion engine may be determined by the starting rotational speed determination unit, the target rotational acceleration may be determined by the target rotational acceleration determination unit based on the starting rotational speed determined by the starting rotational speed determination unit, and the target rotational speed determination unit may sequentially determine the target rotational speed in a manner so that the rotational acceleration of the internal combustion engine becomes the target rotational acceleration determined by the target rotational acceleration determination unit.

### Supplementary Note 12

In the start control method according to Supplementary Note 8, the starting device may include the generator.

### Supplementary Note 13

In the start control method according to Supplementary Note 8, the internal combustion engine may be a gas turbine engine, and transmission of the rotational torque between the gas turbine engine and the generator may be uninterruptible.

### Supplementary Note 14

The program of the present disclosure causes a computer to execute the start control method according to any one of Supplementary Notes 8 to 13.

### Supplementary Note 15

The non-transitory computer-readable storage medium of the present disclosure stores the program according to Supplementary Note 14.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A start control device that controls a starting device for an internal combustion engine configured to drive a generator configured to supply electric power to a moving object, the start control device comprising:
one or more processors that execute computer-executable instructions stored in a memory,
wherein the one or more processors execute the computer-executable instructions to cause the start control device to:
sequentially determine a target rotational speed of the internal combustion engine in a manner so that a rotational acceleration of the internal combustion engine becomes a target rotational acceleration; and
determine, based on the target rotational speed that has been determined, a command torque for controlling the starting device.

2. The start control device according to claim 1, wherein
in a case where the internal combustion engine is started in a state in which the moving object is not moving, the one or more processors cause the start control device to sequentially determine the target rotational speed based on the target rotational acceleration, and
in a case where the internal combustion engine is started in a state in which the moving object is moving, the one or more processors cause the start control device to determine a starting rotational speed of the internal combustion engine as the target rotational speed.

3. The start control device according to claim 1, wherein
the one or more processors cause the start control device to determine the command torque based on information relating to a torque required to maintain a rotational speed of the internal combustion engine at the target rotational speed.

4. The start control device according to claim 1, wherein
the one or more processors cause the start control device to:
determine a starting rotational speed of the internal combustion engine;
determine the target rotational acceleration based on the starting rotational speed that has been determined; and
sequentially determine the target rotational speed in a manner so that the rotational acceleration of the internal combustion engine becomes the target rotational acceleration that has been determined.

5. The start control device according to claim 1, wherein
the starting device includes the generator.

6. The start control device according to claim 1, wherein
the internal combustion engine is a gas turbine engine, and
transmission of a rotational torque between the gas turbine engine and the generator is uninterruptible.

7. A moving object comprising:
the start control device according to claim 1;
the generator; and
the internal combustion engine.

8. A start control method for controlling a starting device for an internal combustion engine configured to drive a generator configured to supply electric power to a moving object, the start control method being executed by one or more processors and comprising:
sequentially determining a target rotational speed of the internal combustion engine in a manner so that a rotational acceleration of the internal combustion engine becomes a target rotational acceleration; and
determining, based on the target rotational speed that has been determined, a command torque for controlling the starting device.

9. The start control method according to claim 8, wherein
in a case where the internal combustion engine is started in a state in which the moving object is not moving, the target rotational speed is sequentially determined based on the target rotational acceleration, and
in a case where the internal combustion engine is started in a state in which the moving object is moving, a starting rotational speed of the internal combustion engine is determined as the target rotational speed.

10. The start control method according to claim 8, wherein
the command torque is determined based on information relating to a torque required to maintain a rotational speed of the internal combustion engine at the target rotational speed.

11. The start control method according to claim 8, wherein
a starting rotational speed of the internal combustion engine is determined,
the target rotational acceleration is determined based on the starting rotational speed that has been determined, and
the target rotational speed is sequentially determined in a manner so that the rotational acceleration of the internal combustion engine becomes the target rotational acceleration that has been determined.

12. The start control method according to claim 8, wherein
the starting device includes the generator.

13. The start control method according to claim 8, wherein
the internal combustion engine is a gas turbine engine, and
transmission of a rotational torque between the gas turbine engine and the generator is uninterruptible.

14. A non-transitory computer-readable storage medium configured to store a program for causing a computer to execute the start control method according to claim 8.
